(19) United States
(12) Patent Application Publication
(10) Pub. No.: US 2015/0083107 A1
(43) Pub. Date: Mar. 26, 2015

(54) GRILLING APPARATUS

(71) Applicant: Busch & Turrek GbR, Neuss (DE)

(72) Inventors: Patrick Busch, Neuss (DE); Thorsten Turrek, Neuss (DE)

(21) Appl. No.: 14/395,008

(22) PCT Filed: Apr. 15, 2013
(86) PCT No.: PCT/IB2013/001193

§ 371 Date: Oct. 16, 2014

(30) Foreign Application Priority Data
Apr. 16, 2012 (DE) 102012103286.6

(51) Int. Cl. F24C 15/20; A47J 37/07

(52) U.S. Cl. CPC F24C 15/2035; A47J 37/0704
USPC 126/25 R; 126/21 A

(57) ABSTRACT

A grilling apparatus (1) with a housing (2), a grilling-product-receiving device (4) held on the housing (2), a heating region (5) arranged below the grilling-product-receiving device (4), an extraction device (6) and at least one filter unit (14, 15, 16, 18) which is connected in terms of flow to the extraction device (6), wherein, during the grilling operation, the extraction device (6) sucks up the fumes arising during the grilling via at least one extraction duct (9) and feeds said fumes to the at least one filter unit (14, 15, 16, 18), wherein a housing cover (7) which is arranged above the grilling-product-receiving device (4) and at least partially covers the latter is provided, and in that the at least one extraction duct (9) is arranged in the housing cover (7).

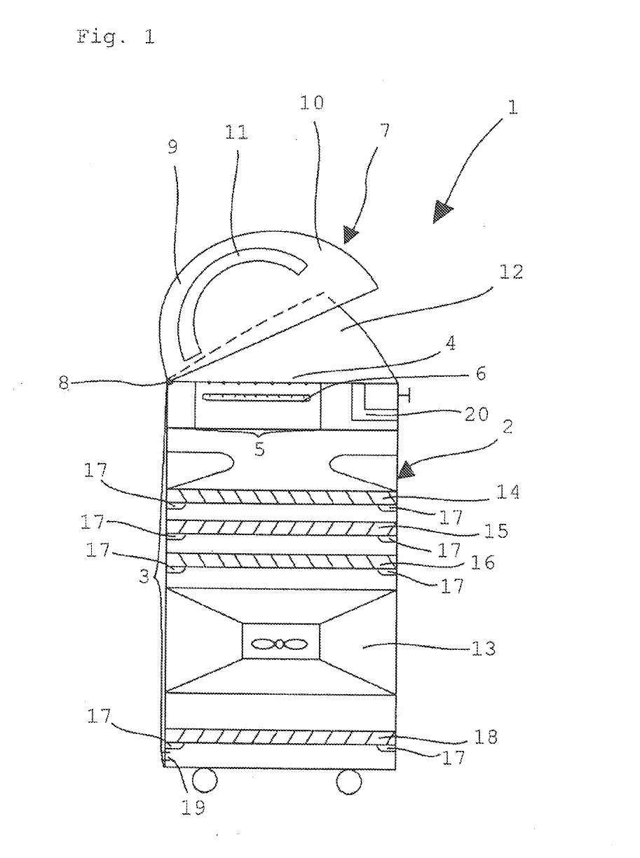

The present invention relates to a barbequing apparatus comprising a housing, a device for receiving items to be barbequed held on the housing, a heating region disposed beneath the device for receiving items to be barbequed, a suction device and at least one filter unit connected fluidically to the suction device, the suction device sucking off any fumes produced by the barbequing during the barbequing operation via at least one suction channel and delivering them to at least one filter unit.

These types of barbequing apparatus are already known from the prior art. For example, DE-A-102 16 011 discloses a barbequing apparatus comprising a housing and a heating source incorporated or that can be inserted into the housing. The housing is cylindrical or has a polygonal cross-section or a cross-section like a conic section and has in its lateral surface a cut-out in which a recess is made into which a heating source for the cooking or barbequing can optionally be inserted from above. On one side of the recess there is formed between the latter and the lateral surface a suction opening provided with a grease filter for a flow of air which is generated by a suction device disposed in the housing. The fumes produced during the barbequing operation are sucked into the internal space defined by the housing via this suction opening and are conveyed here through an odour filter, whereupon the filtered flow of air is released via an outlet opening which is disposed in the region of the recess opposite the suction opening. The flow of air flowing out of the outlet opening is therefore conveyed back towards the suction opening so that it circulates. The suction performance of the suction device will be supported in this way. Due to the fact that the recess made in the housing is open to the top, despite said circulation of the flow of air fumes can, however, not be prevented from passing through the flow of air conveyed via the recess and leaving the barbequing apparatus without being filtered, and this is why odour contamination deriving from the barbequing apparatus can be reduced, but not minimised.

On the basis of this prior art, it is an object of the present invention to devise a barbequing apparatus of the type specified at the start with an alternative structure, and which is associated with very slight odour contamination during the barbequing operation.

In order to achieve this object the present invention provides a barbequing apparatus of the type specified at the start which is characterised in that a housing cover disposed above the device for receiving items to be barbequed and covering the latter at least partly is provided, and that the at least one suction channel is disposed within the housing cover. In other words, the at least one suction channel of the barbequing apparatus according to the invention is not positioned to the side, but directly above the device for receiving items to be barbequed so that the suction takes places substantially in the direction of flow of the fumes rising from the device receiving items to be barbequed and not transversely to the direction of flow. In this way the fumes rising from the device for receiving items to be barbequed can be substantially totally sucked off even with a relatively low performance of the suction device, and this leads to a very small odour contamination. The housing cover, which is held preferably adjustably and in particular pivotably on the housing, screens the barbequing region, by means of which external influences, such as for example the blowing out of the rising fumes due to wind or the like, are minimised.

According to one configuration of the present invention the suction device and the at least one filter unit are positioned in a lower compartment disposed beneath the device for receiving items to be barbequed, by means of which a very compact structure is achieved. The lower compartment can be a separate component of the barbequing apparatus. Alternatively, the lower compartment can also be formed integrally with the housing.

Preferably, the suction opening of the suction channel is disposed in the front region of the housing cover facing the operator of the barbequing apparatus. This is advantageous in that the portion of the fumes produced during the barbequing which is not sucked off directly via the suction opening collects beneath the housing cover and is then sucked off with a time delay. In this way the odour contamination can be further reduced. Moreover, with this type of arrangement of the suction opening it is ensured that sufficient cold air is sucked in, by means of which the temperature of the sucked in fumes is reduced. Accordingly, damage to the filter units or the like due to excessively high temperatures is reliably prevented.

The suction opening advantageously extends over the entire width of the housing cover, by means of which particularly effective suction is achieved.

Advantageously a cold air channel is provided which connects the barbequing region fluidically to the surrounding area. Via such a cold air channel sufficient cold air is delivered to the barbequing region, even with the housing cover closed, in order to be able to reliably prevent excessively high temperatures of the fumes sucked in.

According to one configuration of the present invention there is provided on the inside of the housing cover a grease separator which separates grease from the rising fumes. Accordingly, premature clogging of subsequent filter units is prevented. Furthermore, the temperature of the fumes sucked off through the suction opening is however also reduced by the grease separation, by means of which the subsequent filter units are subjected to less thermal stress.

According to one configuration of the present invention the housing cover is held pivotably on the housing. Accordingly, the operator can vary, as required, the size of the access opening for the handling of the food cooking on the device for receiving items to be barbequed. Furthermore, cooking is also possible with the housing cover totally closed.

Preferably, side apertures are provided which are designed and arranged such that they seal off to the side the space existing between the housing cover and the device for receiving items to be barbequed from draughts when the housing cover is open. Fumes produced by the barbequing can thus be prevented from escaping to the side and odour contamination can accordingly be reduced.

According to one configuration of the present invention the heating region extends over approximately ⅔ of the depth of the housing and is disposed in the rear region facing away from the operator of the barbeque. Thus, no fumes are produced in the front third of the depth of the housing during barbequing. In this way it can be ensured that the fumes are substantially totally sucked off via the suction opening even with the housing cover swung open.

Preferably, one or more filter units are provided in the form of particle filters and/or active charcoal filters, a number of particle filters of different filter classes with increasing fineness in the direction of flow advantageously being used.

The suction device is preferably disposed fluidically between a particle filter and an active charcoal filter. Accordingly, the active charcoal filter acts simultaneously as a sound absorber for the suction device, and this leads to an appreciable reduction in the noise contamination deriving from the barbequing apparatus.

According to one configuration of the present invention there is provided as a filter unit an active charcoal filter which has a filter box open on its upper side, made in the form of a drawer, filled with active charcoal, and which is positioned horizontally in the lower compartment.

An outlet opening for the outlet of the air cleaned by the at least one filter unit is advantageously disposed in the lower region of the lower compartment. In this way a very simple and compact structure of the barbequing apparatus is achieved.

According to one configuration of the present invention the barbequing apparatus is a gas barbeque with gas outlet nozzles disposed in the heating region.

At least one filter element can be accommodated in the suction channel provided in the housing cover. Accordingly, the first filtering of the sucked off fumes takes place before they enter the housing.

Additional features and advantages of the present invention become clear from the following description of an embodiment of the barbequing apparatus according to the invention with reference to the attached drawing which shows a diagrammatic side view of the barbequing apparatus.

The barbequing apparatus 1 comprises a housing 2 which is placed over a lower compartment 3. Held on the housing 2 is a device for receiving items to be barbequed 4 in the form of a barbeque grill. Defined beneath the barbeque grill 4 is a heating region 5 which extends over approximately ⅔ of the depth of the housing 2 in the rear housing region. Disposed within the heating region 5 is a heating device 6 which, in this case, is a gas burner. The housing 2 comprises a housing cover 7 which is held pivotably on the housing 2 in a known manner by a hinge 8. Integrated into the housing cover 7 is a suction channel 9 which is provided with a suction opening 10 and which is disposed in the front region of the housing cover 7 facing the operator of the barbequing apparatus 1. Both the suction channel 9 and the suction opening 10 extend substantially over the entire width of the housing cover 7. A grease separator 11 is held releaseably on the upper inner wall of the housing cover 7. Disposed on the side of the housing 2 are side apertures 12 which extend upwards and co-operate with the side walls of the housing cover 7 like scissors. The side apertures 12 serve to seal off to the side the space existing between the housing cover 7 and the barbeque grill 4 from draughts when the housing cover 7 is open.

The suction channel 9 of the housing cover 7 is connected fluidically to a suction device 13 disposed in the lower compartment 3, three filter units 14, 15 and 16 being accommodated a distance apart from one another in the lower compartment 3 between the housing cover 7 and the suction device 13. The filter units 14, 15 and 16 are respectively box-like in form and rest on the holding devices 17 fastened to the side walls of the lower compartment 3. The filter units 14 to 16 are particle filters with different particle filter classes according to DIN EN 779. In this case the filter unit 14 is a G4 filter, the filter unit 15 is an F7 filter and the filter unit 16 is an F9 filter, and so the fineness of the filter units 14 to 16 increases towards the suction device 13. Provided beneath the suction device 13 is an additional filter unit 18 in the form of an active charcoal filter which has a filter box open on its upper side, made in the form of a drawer, filled with loose active charcoal and which, likewise held by corresponding holding devices 17, is pushed into the lower compartment 3.

Formed beneath the filter unit 18 on the rear side of the lower compartment 3 is an outlet opening 19 which extends over a large part of the width of the lower compartment 3.

A cold air channel 20 connects the barbequing region to the surrounding area.

During operation of the barbequing apparatus 1 items to be barbequed that are placed on the barbeque grill 4 are cooked in the known manner using the heating device 6. Any fumes or smoke rising from the items being barbequed collects in the housing cover 7, any grease contained therein being at least partially separated out by the grease separator 11. The degreased and cooled fumes are then sucked via the suction opening 10 into the suction channel 9 due to the flow of air generated by the suction device 13 and from here on into the lower compartment 3. Due to the fact that the heating region 5 in the rear housing region is only disposed over ⅔ of the depth of the housing, the fumes rising from the barbeque grill 4 are substantially completely captured by the suction effect existing along the suction opening 10. Moreover, by virtue of the arrangement of the suction opening 10 in the front region of the housing cover 7 facing the operator of the barbequing apparatus 1 in the open state of the housing cover 7, sufficient cold air is always sucked out of the surrounding area, by means of which the temperature of the sucked in fumes is prevented from having a critical effect. In the closed state of the housing cover 7 a sufficient supply of cold air via the cold air channel 20 is guaranteed. The flow of air passing into the lower compartment 3 is then filtered consecutively in the filter units 14, 15 and 16 and in this way is freed of the particles swept along. Additional filtering takes place in the filter unit 18 which is connected downstream of the suction device 13. By virtue of the arrangement of the filter element 18 this serves not only to filter the flow of air, but at the same time also serves as a sound absorber for the suction device 13, by means of which the sound contamination deriving from the barbequing apparatus 1 is clearly reduced. The filtered and substantially odour-neutral flow of air is finally released from the lower compartment 3 via the outlet opening 19.

1. A barbequing apparatus (1) comprising a housing (2), a device for receiving items to be barbequed (4) held on the housing (2), a heating region (5) disposed beneath the device for receiving items to be barbequed (4), a suction device (6) and at least one filter unit (14, 15, 16, 18) connected fluidically to the suction device (6), the suction device (6) sucking off any fumes produced by the barbequing during the barbequing operation via at least one suction channel (9) and delivering them to at least one filter unit (14, 15, 16, 18), wherein a housing cover (7) disposed above the device for receiving the items to be barbequed (4) and covering the latter is provided which is held on the housing (2) adjustably between an open position and a closed position, that a cold air channel is provided that connects the barbequing region fluidically to the surrounding area, and that at least one suction channel (9) is disposed within the housing cover (7).

2. The barbequing apparatus (1) according to claim 1, characterized in that the suction device (6) and at least one filter unit (14, 15, 16, 18) are positioned in a lower compartment (3) disposed beneath the device for receiving items to be barbequed (4).

3. The barbequing apparatus (1) according to claim 1, characterized in that a suction opening (10) of the suction channel (9) is disposed in the front region of the housing cover (7) facing the operator of the barbequing apparatus (1), the suction opening (10) preferably extending over the entire width of the housing cover (7).

4. The barbecuing apparatus (1) according to claim 1, characterized in that a grease separator (11) is provided on the inside of the housing cover (7).

5. The barbecuing apparatus (1) according to claim 1, characterized in that the housing cover (7) is held pivotably on the housing (2).

6. (canceled)

7. The barbecuing apparatus (1) according to claim 5, characterized in that side apertures (12) are provided which are designed and arranged such that they seal off to the side the space existing between the housing cover (7) and the device for receiving the items to be barbequed (4) from draughts when the housing cover (7) is open.

8. The barbecuing apparatus (1) according to claim 1, characterized in that the heating region (5) extends over ⅔ of the depth of the housing (2) and is disposed in the rear region facing away from the operator of the barbequing apparatus (1).

9. The barbecuing apparatus (1) according to claim 1, characterized in that one or more filter units (14, 15, 16, 18) are provided in the form of particle filters and/or active charcoal filters, the suction device (6) preferably being disposed fluidically between a particle filter (14, 15, 16) and an active charcoal filter (18).

10. The barbecuing apparatus (1) according to claim 2, characterized in that there is provided as a filter unit (18) an active charcoal filter which has a filter box open on its upper side, made in the form of a drawer, filled with active charcoal, and which is positioned horizontally in the lower compartment (3).

11. The barbecuing apparatus (1) according to claim 2, characterized in that an outlet opening (19) for the outlet of the air cleaned by the at least one filter unit (14, 15, 16, 18) is disposed in the lower region of the lower compartment (3).

12. The barbecuing apparatus (1) according to claim 1, characterized in that the latter is a gas barbeque with gas outlet nozzles disposed in the heating region (5).

13. The barbecuing apparatus (1) according to claim 1, characterized in that at least one filter element is accommodated in the suction channel (9) provided in the housing cover (7).

14. The barbecuing apparatus (1) according to claim 3, characterized in that a grease separator (11) is provided on the inside of the housing cover (7).

15. The barbecuing apparatus (1) according to claim 3, characterized in that the heating region (5) extends over ⅔ of the depth of the housing (2) and is disposed in the rear region facing away from the operator of the barbequing apparatus (1).
